(19) United States
(12) Patent Application Publication
(10) Pub. No.: US 2012/0201097 A1
(43) Pub. Date: Aug. 9, 2012

(54) ARRAY SYSTEM WITH HIGH RESOLVING POWER AND HIGH IMAGE QUALITY

(76) Inventor: Peter A. Fox, Port Coquitlam (CA)

(21) Appl. No.: 13/353,560

(22) Filed: Jan. 19, 2012

Related U.S. Application Data
(60) Provisional application No. 61/441,350, filed on Feb. 10, 2011.

(30) Foreign Application Priority Data
Feb. 9, 2011 (NO) 2011 0225

(51) Int. Cl. G01S 15/00

(52) U.S. Cl. 367/87

(57) ABSTRACT

A Transmit/Receive Array combination with high resolving power wherein the Signal Dependent Noise contributors to Image Quality, as determined by the Peak Sidelobe Ratio (PSLR) and the Integrated Sidelobe Ratio (ISLR) are controlled largely independently of the Main Lobe Width. The receiving array is comprised of a number of discrete elements, nominally at half wavelength spacing. The Receive Array is weighted to aid in the control of PSLR and ISLR. The Transmit Array is comprised of a sparse array of discrete elements (more than two). The Transmit Array is longer than the receive array. The transmit array may be weighted to aid in the control of PSLR and ISLR.

### CROSS-REFERENCE TO RELATED APPLICATIONS

This patent application claims priority from, and incorporates by reference, U.S. Patent Application No. 61/441,350, filed on Feb. 10, 2011.

### BACKGROUND OF THE INVENTION

1. Field of the Invention

This invention concerns a system of arrays or antennas to be used in Active Imaging Systems with high resolving power and with high image quality.

The main requirement of such systems is to obtain the highest quality images, where Image Quality is measured as a combination of three key elements, the first being the resolving power (as determined by the Angular Resolution), and the second and third being the Signal Dependent Noise contributors to Image Quality, as determined by the Peak Sidelobe Ratio (PSLR) and the Integrated Sidelobe Ratio (ISLR).

When imaging point like targets, the PSLR controls the extent to which a point in the image, immediately adjacent to the mainlobe, but outside the mainlobe (as defined by the Angular Resolution), will interfere with the desired point to be imaged within the mainlobe. When imaging distributed targets, such as the sea floor, or the earth's surface, the ISLR provides a measure of the undesired proportion of the Mainlobe energy that arises from the integrated contributions of all the targets from all the extended sidelobes beyond the Mainlobe Angular width. Both PSLR and ISLR may be controlled by applying weighting functions to the Transmitter and Receiver Arrays, but the result is an inevitable increase in the Mainlobe Angular width. A full treatment is given in [Barton, D. K. and Ward, H. R., “Handbook of Radar Measurements”, Prentice Hall, Eaglewood Cliffs, N.J. 1969.]

Traditionally Multibeam Imaging performance in terms of Image Quality has been poorer than that of Single Beam Imaging systems; for a given array or antenna length the PSLR and ISLR are higher and the Angular Resolution is worse.

In a Single Beam Imaging Sonar the angular resolution is determined by the product of the transmit and receive beams. Thus a 20 wavelength long transducer will produce a receive beam with an Angular Resolution of approximately 1/20 radian. Of course if the same transducer is used for transmit and receive, then the effective beam pattern is the product of the transmit and receive beam patterns. The result is that the single beam sonar with a 20 wavelength transducer will produce an Angular Resolution significantly better than 1/20th radian. A conventional Multibeam Imaging System with a broad transmit beam provides no additional directivity from the Transmitter, and thus, from a 20 wavelength Receiving transducer, will produce an image with a Mainlobe Angular Resolution about 1.4 times wider than the Mainlobe Angular Resolution of the single beam system.

The Peak Sidelobe Ratio also has a powerful effect on the image quality. In an unweighted array the Peak Sidelobe is −13.2 db down from the mainlobe. In a Single Beam Imaging Sonar where the unweighted transmitter array and the unweighted receiver array are the same length, and are used in a Monostatic manner, the Transmit pattern and the Receive pattern are multiplied, and the resulting two way Peak Sidelobe Ratio (PSLR) is −26.4 dB; a very respectable sidelobe. A conventional Multibeam Imaging System with a broad transmit beam and an unweighted receiver array provides no additional sidelobe suppression through the two way product, and thus will produce an image with a PSLR of −13.2 dB, significantly higher than the PSLR of the Single Beam Imaging system.

The Integrated Sidelobe Ratio also has a powerful effect on the image quality. A conventional Multibeam Imaging System with a broad transmit beam and an unweighted receiver array provides no additional sidelobe suppression through the two way product, and thus will produce an ISLR that is significantly higher than the ISLR of the Single Beam Imaging system.

2. Description of Prior Art

In U.S. Pat. No. 4,234,939 Grall established that it is possible to increase the resolving power of an array. He limited the invention to the case where the transmit and receive arrays have substantially the same length, and the transmit array comprised two elements only, the first and second transmitting elements being placed at the extremities of the said transmit array. Grall named this arrangement of two transmitting transducers a “transmission of the interferometric type”. Grall also established that through the use of frequency division multiplexing, said array with transmission of the interferometric type was capable of generating two patterns, the second of which has maxima interposed in the minima of the first. The result of this was an imaging system that achieved a resolution of 0.442λ/L, rather than the resolution of 0.882λ/L that was achieved without the transmission of the interferometric type.

In U.S. Pat. No. 4,234,939 Grall made no claims regarding the sidelobe levels; either Peak Sidelobe Levels (PSLR) or Integrated Sidelobe Levels (ISLR).

In U.S. Pat. No. 4,510,586 Grall et al. claimed a similar system, but this time removed the constraint that the first and second transmitting elements be placed at the extremities of the transmit array. Grall et al. however still claimed that the array system comprised a transmit array with two elements, and a receive array that was longer than the transmit array. In U.S. Pat. No. 4,510,586 Grall et al. did note that the invention allowed the spacing between the two transmitting transducers to be reduced, and the receive transducer signals to be weighted, thus providing high angular resolution and low secondary lobe levels.

The major drawback of the prior art described in U.S. Pat. No. 4,510,586 Grall et al. is embodied in FIG. 5 of U.S. Pat. No. 4,510,586 Grall et al. In this figure the sidelobe levels are reduced at the expense of increasing the mainlobe width, and thus at the detriment to the high resolving power.

Another example of the known art is shown in U.S. Pat. No. 5,101,383. This patent essentially uses a Frequency Scanned Array, where the two secondary grating lobes are steered by changing the frequency, and the two secondary lobes are separated with two receivers, covering disjoint sectors.

US2004/0047236 concerns Synthetic Aperture Sonar, and in particular an interferometric mode of operation that appears to be somewhat like split beam processing for improving bearing estimation. The second claim relates to using two arrays to aid in self-calibration.

### SUMMARY OF THE INVENTION

This invention concerns an array system to project and detect reflected waves, such as sonar waves, with high resolving power, comprising a transmitting array and a receiving array, the receiving array being formed of a plurality transducers placed along its length L_{R}, and the transmitting array being formed of a plurality of transmitting transducers, placed along its length L_{T}, where L_{T} is characterised by being longer than L_{R}. Both the transmitting array and the receiving array are connected to phase shifting and amplitude weighting means, said means being capable of being changed either during the transmission of a pulse, or from one pulse to the next. The transmitter driving the transmitting array is capable of changing the pulse shape (in terms of amplitude and time varying frequency or phase) over time within the pulse, or from one pulse to the next.

The invention specifically enables the optimization of Image Quality through the control of the PSLR and the ISLR without degrading the Angular Resolution, by using a sparse Transmitter Array and a Receiver Array with specific excitations and weighting.

This is obtained with a system as stated above being characterized as specified in the independent claim.

Thus a Transmit/Receive Array combination is obtained with high resolving power wherein the Signal Dependent Noise contributors to Image Quality, as determined by the Peak Sidelobe Ratio (PSLR) and the Integrated Sidelobe Ratio (ISLR) are controlled largely independently of the Main Lobe Width. The receiving array is comprised of a number of discrete elements, nominally at half wavelength spacing and may be weighted to aid in the control of PSLR and ISLR. The Transmit Array is comprised of a sparse array of discrete elements (more than two) and is longer than the receive array. The transmit array may also be weighted to aid in the control of PSLR and ISLR.

By a judicious choice of the spacing of the plurality of transmitting transducers, which will be elaborated on later, and by varying the weighting function applied to the transmitting array, as well as the weighting function applied to the receiving array, the key Image Quality Parameters of the composite Transmit/Receive beampattern, namely the mainlobe beamwidth, determining the high resolution, may be held nominally constant while the Peak Sidelobe Ratio and the Integrated Sidelobe Ratio may be independently controlled with no degradation of the mainlobe beamwidth. Two examples are considered to show the relationship between element spacing and weighting of both the Transmitting Array and the Receiving Array.

### BRIEF DESCRIPTION OF THE DRAWINGS

The invention will be described more in detail below with reference to the accompanying drawings, illustrating the invention by way of examples.

FIG. 1 illustrates the transmitter en receiver arrays.

FIG. 2 illustrates the beam patterns according to a first embodiment of the invention.

FIG. 3 illustrates the beam patterns according to a second embodiment of the invention.

FIG. 4 illustrates the quality parameters according to the second embodiment of the invention.

### DETAILED DESCRIPTION OF ILLUSTRATIVE EMBODIMENTS OF THE INVENTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

In the first example embodiment, both the Transmitting Array and the Receiving Array are unweighted. This example is chosen to illustrate the first element of the invention, that greater Image Quality (as characterized by Angular Resolution, the Peak Sidelobe Ratio (PSLR) and the Integrated Sidelobe Ratio (ISLR)) may be achieved where L_{T} is characterised by being longer than L_{R}.

In the second example embodiment, a shorter Transmitting Array and the Receiving Array are weighted. This example is chosen to illustrate that even greater Image Quality (as characterized by Angular Resolution, the Peak Sidelobe Ratio (PSLR) and the Integrated Sidelobe Ratio (ISLR)) may be achieved where L_{T} is also characterised by being longer than L_{R} and where Transmitting Array and the Receiving Array are weighted.

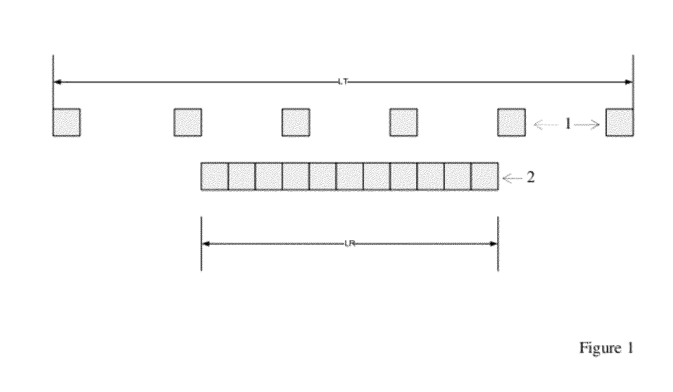

In the first example of an embodiment consider a Transducer (Array) geometry that is a specific case of the general geometry, in this case a transmitting array of 6 elements as shown in FIG. 1, where the upper row of elements 1 constitutes the transmitter array with a length L_{T} and the lower row of elements 2 is the receiver array having a length L_{R}. In this embodiment allow the Transmitting Array to have 6 elements uniformly distributed over a length L_{T}=0.2090 m and the Receiving Array to have 64 elements uniformly distributed over a length L_{R}=0.1114 m. The Transmitting Array is longer than the receiving array. Both of the arrays in this first example embodiment are unweighted, meaning that the transducers in the transmitter array have the same signal strength and the transducers in the receiver array have the same sensitivity.

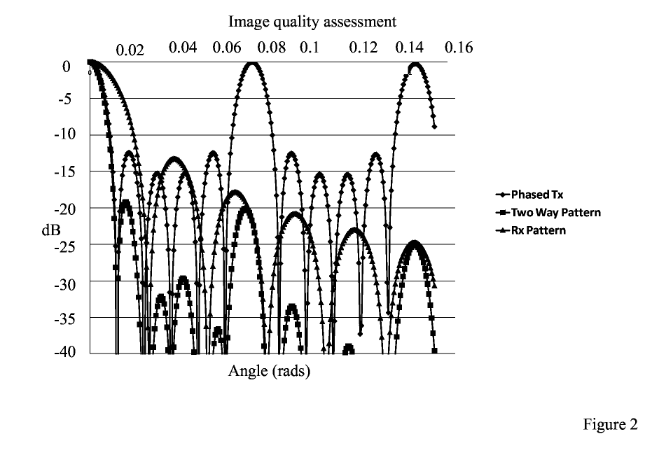

In FIG. 2, the Receive Beam is seen to have a standard sinc function shape, typical of an unweighted array. The Transmit Beam is seen to have a repetitive shape, with the first Transmit lobe appearing at 0.0698 radians. In this example embodiment, the first sidelobe of the Receive Beam has been placed almost coincident with the third minima in the repeating Transmit Beam Pattern appearing at 0.0343 radians. The length L_{R}=0.1114 m. is the determinant of the placement of this first sidelobe of the Receive Beam. The Product of the Receive Beam and the Transmit Beam is plotted in FIG. 2, and it may be seem that the first sidelobe of the receive pattern (originally the Peak Sidelobe, with a PSLR of −13.26 dB) has been suppressed by the minima in the Transmit Beam, and has been reduced to two lobes, the larger of which is approximately −29 dB. The second sidelobe on the Receive Beam are also suppressed by a few dB, while other sidelobes are also suppressed, in some cases by more than 10 dB. This the integrated contributions of all the targets from all the extended sidelobes beyond the Mainlobe Angular width will be suppressed and the ISLR will improve.

In this first example embodiment, the PSLR has been improved from −13.26 dB to −19.21 dB, while the ISLR has been improved from −22.31 dB to −28.92 dB. At the same time the Mainlobe width has narrowed from 1.05° to 0.54°. Thus this first example embodiment, possibly the simplest embodiment of the invention, has resulted in Higher Resolving Power, due to the reduced Mainlobe Angular width as well as Higher Image Quality, as determined by the reduced PSLR and the reduced ISLR. This increased Image Quality has been achieved at the cost of 5 additional transmitters, and their associated drivers.

The utility of the invention is well demonstrated by this example embodiment. To achieve similar results by a conventional broad transmitter and a weighted receiver would require a receiver more than two or three times the length (and thus with more than two of three times the number of elements, 128 or 192 extra channels), and with very strong weighting on the receiver. The extra Receive Array elements are very expensive, as are the Receive channels and the computing power required to process them. The Invention allows all the key determinants of image quality to be significantly improved by the simple addition of five Transmitter elements as is illustrated in FIG. 1.

The addition of the five extra Transmitter elements, with the selected spacing in example embodiment 1, have enabled the Transmitter Pattern to be shaped into the repeating lobes, and in particular, have allowed the first sidelobe of the receiver to be placed coincident with a selected minima of the transmitter. The cost of adding five transmitter elements and the associated drivers is significantly less than the cost of adding 64 or 128 receiver channels and their associated receivers.

It is clear in this example embodiment, that there are unimaged gaps between the repeating lobes of the transmitted beampattern. These gaps have to be filled in to make a complete image, and there are two alternative methods to accomplish this. In the first method the transmitter may be configured to transmit a plurality of pulses in succession, with the phase relationship between transmit elements changing from one transmission to the next such that the plurality of transmitted pulses in succession fills in the gaps sequentially. As each new transmit beam pattern is generated the receiver forms beams that are electronically steered to coincide with the maxima of the associated transmitter beam pattern. In the second method the transmitter may transmit once only, but the transmitted pulse may be segmented into a plurality of non-overlapping subbands, or a plurality of low cross-correlation sub-pulses. In the second method of filling in the gaps, the gaps are filled in with a single pulse, by filtering the subbands to separate them into the required plurality, and forming the receive beams in the corresponding directions, or by correlation processing of the subbands to separate them into the required plurality, and forming the receive beams in the corresponding directions.

While the first example embodiment clearly demonstrates that the PSLR and the ISLR have been significantly improved, and the Main lobe width has been significantly narrowed, the example embodiment has not incorporated all the characteristics of the invention.

In a second example embodiment consider a Transducer (Array) geometry that is again a specific case of the general geometry. In this embodiment allow the Transmitting Array to have 4 elements, and the Receiving Array to have 64 elements. In this embodiment allow the Transmitting Array to have 4 elements uniformly distributed over a length L_{T}=0.1254 m and the Receiving Array to have 64 elements uniformly distributed over a length L_{R}=0.0975 m. The Transmitting Array is again longer than the receiving array. In contrast to the first embodiment, both of the arrays in this second example embodiment are weighted.

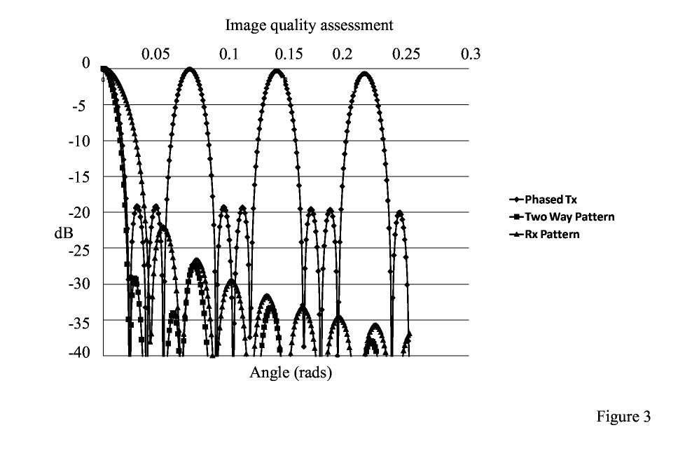

The results are shown in FIG. 3. In this example embodiment the transmit array is significantly longer than the receive array, and the transmitting array has been weighted to reduce the transmitter sidelobes, which can be seen to be approximately −18 dB. The transmitter array weighting has been selected to be 0.6, 1, 1, 0.6; the central two elements transmitting a unity signal, while the outer two elements transmit 60% of that signal.

In this example embodiment the Receiver Array has also been significantly weighted; with a Kaiser Bessel weighting function, an approximation to the prolate-spheroidal window, for which the ratio of the mainlobe energy to the sidelobe energy is maximized. For a Kaiser window of a particular length, the parameter B controls the sidelobe height. [Reference: James F. Kaiser and Ronald W. Schafer, On the Use of the Io-Sinh Window for Spectrum Analysis, IEEE Transactions on Acoustics, Speech and Signal Processing, Vol. ASSP-28, No. 1, February 1980, pp 105-107.]

In this example embodiment the Kaiser Bessel parameter is set to beta=2.6. The consequences of this significant weighting of the Receiver Array is that the PSLR of the Receive Array is approximately −26 dB, at the cost of a significant broadening of the Receiver Mainlobe. Due to the fact that the transmitting array is significantly longer than the receiving array, the mainlobe width of the composite beam pattern formed by the multiplication of the Receiver Array Pattern with the Transmit Array Pattern is however almost completely determined by the Transmit Array Pattern.

This second example embodiment demonstrates the key claims of this invension; the ability to cost effectively control the PSLR and the ISLR without degrading the Resolution.

The key claims of this invention are further demonstrated when the Kaiser-Bessel weighting on the Receiver Array is varied, to further demonstrate the claim that the Mainlobe Angular Beamwidth may be held constant while the PSLR and ISLR are varied by changing the Kaiser-Bessel weighting parameter beta.

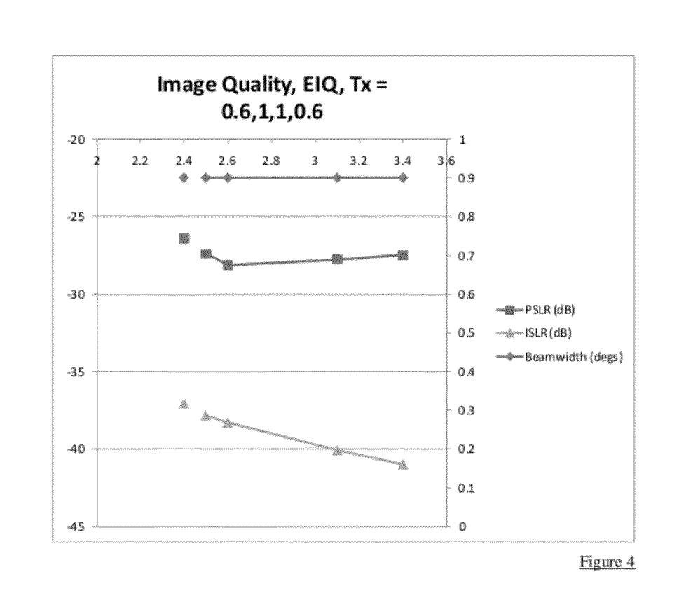

FIG. 4 shows the key Image Quality Parameters, PSLR, ISLR and Beamwidth for the second example embodiment. On the left hand axis the PSLR and ISLR are in dB. On the right hand axis the Beamwidth is in degrees. On the horizontal axis the “beta” parameter of the Kaiser Bessel (KB) weighting function that has been used for this second example embodiment is shown. All Image Quality Parameters are plotted as functions of the “beta” parameter of the Kaiser Bessel weighting function. In this second example embodiment the Transmitter Array weighting has been arbitrarily fixed at 0.6, 1, 1, 0.6.

Clearly the PSLR may be minimised, for a KB beta parameter of 2.4. However, the PSLR may be kept almost constant, while the ISLR is driven below −40 dB, by increasing the KB Beta parameter.

When the second example embodiment is compared to the Image Quality Parameters of a Single Beam Sonar, derived by modeling the Single Beam Imaging system as unweighted transmitting and receiving arrays of equal length (a typical embodiment of a single beam imaging system), and with that equal length in turn equal to the length of the receiving array, the length L_{T}=L_{R}=0.0975 m, the results indicate that the Image Quality of a Multibeam Imaging system can be made to approach that of a Single Beam Imaging System.

The Single Beam Imaging system Image Quality parameters are derived by multiplying the transmit and receive patterns. As noted by Grail (U.S. Pat. No. 4,234,939) the beamwidth of the product is reduced; in this single beam example the beamwidth is reduced to 0.85°. The PSLR is simply computed as twice the PSLR of the Receiving Array of the Single Beam Imaging System; −26.54 dB. The ISLR of the Receiving Array of the Single Beam Imaging System is computed by integrating all sidelobes outside of the mainlobe, to get −39.77 dB.

Examining FIG. 4 which shows the key Image Quality Parameters, PSLR, ISLR and Beamwidth for the second example embodiment it may be seen that the Mainlobe Beamwidth remains constant at 0.9°, while the PSLR reaches a minimum of −28.12 dB for a Kaiser-Bessel beta parameter of 2.6, and the ISLR may be reduced to −41.0 dB for a Kaiser-Bessel beta parameter of 3.4.

Thus, as stated earlier, by a judicious choice of the spacing of the plurality of transmitting transducers, and by varying the weighting function applied to the transmitting array, as well as the weighting function applied to the receiving array, the key Image Quality Parameters of the composite Transmit/Receive beampattern, namely the mainlobe beamwidth, determining the high resolution, may be held nominally constant while the Peak Sidelobe Ratio and the Integrated Sidelobe Ratio may be independently controlled with no degradation of the mainlobe beamwidth, and the results confirm that the Image Quality of a Multibeam Imaging system can be made to approach that of a Single Beam Imaging System.

The choice of the spacing of the plurality of transmitting transducers, and the choice of the weighting function applied to the transmitting array, as well as the choice of the weighting function applied to the receiving array may be accomplished in a multiplicity of ways; the simplest method is elaborated in detail. It has been established in the example embodiments above that the Mainlobe Beamwidth is primarily determined by the length L_{T} of the Transmitting Array. Thus, having specified the Mainlobe Beamwidth, the length L_{T} of the Transmitting Array is fixed.

The second specification that needs to be established is the maximum number of images required to fill in the gaps between the Transmitting Array Maxima; whether these gaps are filled with sequential steered transmitter pulses, or with a plurality of non-overlapping steered transmitter pulses implemented as sub-bands within a single pulse, or a plurality of steered transmitter pulses implemented as low cross-correlation sub-pulses; the gaps being filled in for each generated new transmit beam pattern by the receiver forming beams that are electronically steered to coincide with the maxima of the associated transmitter beam pattern. The constraints on the maximum number of sequential pulses are established by the required complete image update rate. The constraints on the number of sub-bands or sub-pulses are established by the total transmit pulse time and available bandwidth. Having fixed the maximum number of images required, the angular spacing between the repeating Transmitter Array lobes is established, such that the spacing is the product of the Mainlobe Beamwidth and the maximum number of images required.

When the angular spacing between the repeating Transmitter Array lobes has been established, the length L_{T} of the Transmitting Array is then populated with a sparse array of elements, with the element spacing specified as the ratio of the wavelength to the angular spacing between the repeating Transmitter Array lobes, such that the spacing is the product of the Mainlobe Beamwidth and the maximum number of images required. The physical configuration of the transmitter array is thus determined.

The physical configuration of the receiver array is that the elements be spaced such that grating sidelobes are not formed within the overall imaging sector (typically requiring a half wavelength spacing). The overall length L_{R} of the receive array is then chosen to place the first sidelobe of the receive pattern near a null in the Transmitter Array pattern.

The weightings to be applied to the Transmitter Array and the Receiver Array may then be determined by building a simple model of the two arrays, and manually varying the weighting parameters, or alternatively, a cost function may be established from the three Image Quality Parameters (Mainlobe Beam Width, PSLR and ISLR), and an optimisation routine may be run to find suitable values of the weightings to be applied to the Transmitter Array and the Receiver Array.

Although various embodiments of the system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A system of arrays or antennas for generating and detecting waves, such as sonar waves, with high image quality, comprising
a transmitter array being formed of a plurality of transmitting transducers, placed along its length L_{T}, and
a receiver array being formed of transducers placed along its length L_{R}, where L_{T} is characterised by being longer than L_{R},
the system also including drivers being connected to said transmitting transducers, and a plurality of receivers connected to said receiving transducers,
said drivers and receivers being coupled to a control unit adapted to control the transmitter and receiver beams so as to have overlapping maxima in a chosen lobe and none-overlapping side-lobes so as to suppress the information received outside said chosen lobe.

2. An array system according to claim 1, wherein said drivers connected to said transmitting transducers are capable of driving signals, capable of changing the pulse amplitude (for array weighting) and the pulse shape (in terms of amplitude and time varying frequency or phase) over time, within the pulse, or from one pulse to the next.

3. An array system according to claim 1, wherein said receivers connected to said receiving transducers are capable of changing the receiving element phase and amplitude from one pulse to the next.

4. An array system according to claim 1, comprising an electronic beamforming system connected to the outputs of said receivers, provided with processing means processing signals from the outputs of said receivers into beams, wherein the entire received signal from each transmission is processed into one part of an image, or wherein the received signal is processed by filtering the subbands to separate them into the required plurality, and forming the receive beams in the corresponding directions, or by correlation processing of the subbands to separate them into the required plurality, and forming the receive beams in the corresponding directions.

5. An array system according to claim 1, wherein said transmitters are phased to produce maxima sequentially from pulse to pulse wherein the transmitter is configured to transmit a plurality of pulses in succession, with the phase relationship between the transmit elements changing from one transmission to the next, such that the transmitter fills in the gaps sequentially, wherein for each generated new transmit beam pattern the receiver forms beams that are electronically steered to coincide with the maxima of the associated transmitter beam pattern.

6. An array system according to claim 1, wherein said transmitters are phased to produce maxima within the pulse wherein the phase relationship between the transmit elements changing from pulse segment to pulse segment within the pulse, such that the transmitter fills in the gaps sequentially within a single pulse, the transmitted pulse being segmented into a plurality of orthogonal subbands, wherein for each generated transmit beam pattern the receiver forms beams that are electronically steered to coincide with the maxima of the associated transmitter beam pattern by filtering the subbands to separate them into the required plurality, and forming the receive beams in the corresponding directions.

7. An array system according to claim 1, wherein said transmitters are phased to produce maxima within the pulse wherein the phase relationship between the transmit elements changing from pulse segment to pulse segment within the pulse, such that the transmitter fills in the gaps sequentially within a single pulse, the transmitted pulse being segmented into a plurality of low cross-correlation sub-pulses, wherein for each generated transmit beam pattern the receiver forms beams that are electronically steered to coincide with the maxima of the associated transmitter beam pattern by matched filtering the low cross-correlation sub-pulses to separate them into the required plurality, and forming the receive beams in the corresponding directions.

8. An array system according to claim 1, wherein said transmitters are phased to produce maxima within the pulse wherein the phase relationship between the transmit elements constant within the pulse, the transmitted pulse being a superposition of orthogonal pulses, such that the transmitter fills in the gaps sequentially within a single pulse wherein for each generated transmit beam pattern the receiver forms beams that are electronically steered to coincide with the maxima of the associated transmitter beam pattern by matched filtering the orthogonal pulses to separate them into the required plurality, and forming the receive beams in the corresponding directions.

9. An array system according to claim 1, wherein said transmitters are phased to produce maxima within the pulse wherein the phase relationship between the transmit elements constant within the pulse, the transmitted pulse being a superposition of low cross-correlation pulses, such that the transmitter fills in the gaps sequentially within a single pulse wherein for each generated transmit beam pattern the receiver forms beams that are electronically steered to coincide with the maxima of the associated transmitter beam pattern by matched filtering the low cross-correlation pulses to separate them into the required plurality, and forming the receive beams in the corresponding directions.
